(19) United States
(12) Patent Application Publication
(10) Pub. No.: US 2005/0107030 A1
(43) Pub. Date: May 19, 2005

(54) Integrated AM/FM/SDARS radio

(76) Inventors: Imtiaz Zafar, Sterling Heights, MI (US); Ahmad B. Pakray, Rochester Hills, MI (US); Kenneth P. Lee, Bingham Farms, MI (US); J. Robert Dockemeyer JR., Kokomo, IN (US)

Correspondence Address: DELPHI TECHNOLOGIES, INC., M/C 480-410-202, PO BOX 5052, TROY, MI, 48007, US

(21) Appl. No.: 10/717,242

(22) Filed: Nov. 19, 2003

(51) Int. Cl. H04B 1/38

(52) U.S. Cl. 455/3.02; 455/90.3

(57) ABSTRACT

A stationary terrestrial/satellite antenna and receiver system for reception of AM, FM, satellite and terrestrial rebroadcast satellite signals is disclosed. The stationary terrestrial/satellite antenna and receiver system includes a stationary satellite antenna, a stationary terrestrial antenna, and a stationary integrated head unit. The stationary satellite antenna is positioned on a surface and receives satellite and terrestrial rebroadcast satellite signals. The stationary terrestrial antenna is positioned on the surface and receives AM/FM terrestrial signals. The satellite and terrestrial antenna are mounted on a mounting assembly including a low noise amplifier circuit and a bezel. The bezel is adapted to contain the low noise amplifier. The stationary integrated head unit is positioned on the surface and includes an AM/FM terrestrial receiver/tuner human interface and a satellite receiver/tuner human interface. The terrestrial antenna is connected to the AM/FM terrestrial receiver/tuner human interface and the satellite antenna is connected to the satellite receiver/tuner human interface via a conduit. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The invention relates generally to digital radios. More particularly, the invention relates to a stationary terrestrial/satellite antenna and receiver.

### BACKGROUND OF THE INVENTION

With reference to FIG. 1, a known stationary satellite digital audio radio 1 that provides for the reception of satellite transmission signals is commercially available and sold under the trade name SKYFi™ from XM Satellite Radio Inc. of Washington, D.C. The known stationary satellite digital audio radio 1 includes a satellite digital audio radio services (SDARS) antenna and electronics 2 enclosed by a housing 3 for the reception of SDARS signals. The housing 3 may be placed on a surface, S, such as a desk, table, or countertop. Alternatively, the surface, S, may be window glass that faces the direction of satellite transmissions. A cable 4 communicates the received signals to an SDARS receiver/tuner human interface (HMI) 5 that may include a display, control buttons, and speakers.

Satellite-based digital audio radio services cover a large geographic area, such as North America. SDARS generally employs either geo-stationary orbit satellites or highly elliptical orbit satellites that receive up-linked programming which, in turn, is rebroadcast directly to the stationary satellite digital audio radio 1 on the ground that subscribes to the service. The stationary satellite digital audio radio 1 is programmed to receive and unscramble the digital data signals, which typically include many channels of digital audio. In addition to broadcasting the encoded digital quality audio signals, the satellite-based digital audio radio service may also transmit data within a data bandwidth that may be used for various applications. The broadcast signal may also include other information for reasons such as advertising, informing the subscriber of warranty issues, providing information about the broadcast audio information, and providing news, sports, and other entertainment broadcasting. Accordingly, the digital broadcast may be employed for any of a number of satellite audio radio, satellite television, satellite Internet, and various other consumer services.

Although adequate in providing a national broadcast signal (e.g. a signal broadcast and received by subscribers across North America), the stationary satellite digital audio radio 1 does not supply the subscriber with local content (i.e. a region-wide broadcast signal) offered on AM/FM frequencies. If the subscriber desires local broadcast content, the subscriber must employ a secondary radio that provides local content programming on AM/FM frequencies. Accordingly, a need therefore exists for an improved stationary satellite digital audio radio that offers national and local programming content.

### SUMMARY OF THE INVENTION

The present invention relates to a stationary terrestrial/satellite antenna and receiver system for reception of AM, FM, satellite and terrestrial rebroadcast satellite signals. The stationary terrestrial/satellite antenna and receiver system includes a stationary satellite antenna, a stationary terrestrial antenna, and a stationary integrated head unit. The stationary satellite antenna is positioned on a surface and receives satellite and terrestrial rebroadcast satellite signals. The stationary terrestrial antenna is positioned on the surface and receives AM/FM terrestrial signals. The satellite and terrestrial antenna are mounted on a mounting assembly including a low noise amplifier circuit and a bezel. The bezel is adapted to contain the low noise amplifier. The stationary integrated head unit is positioned on the surface and includes an AM/FM terrestrial receiver/tuner human interface and a satellite receiver/tuner human interface. The terrestrial antenna is connected to the AM/FM terrestrial receiver/tuner human interface and the satellite antenna is connected to the satellite receiver/tuner human interface via a conduit.

### BRIEF DESCRIPTION OF THE DRAWINGS

The novel features and advantages of the present invention will best be understood by reference to the detailed description of the specific embodiments which follows, when read in conjunction with the accompanying drawings, in which:

FIG. 1 illustrates a known stationary satellite digital audio radio system that provides for the reception of satellite transmission signals;

FIG. 2A illustrates an integrated dual element stationary terrestrial/satellite antenna and receiver system for reception of AM, FM, satellite and terrestrial rebroadcast satellite signals according to one embodiment of the invention;

FIG. 2B illustrates an integrated single element stationary terrestrial/satellite antenna and receiver system for reception of AM, FM, satellite and terrestrial rebroadcast satellite signals according to another embodiment of the invention;

FIG. 3 is a representative view of the stationary terrestrial/satellite antenna and receiver system according to FIGS. 2A and 2B;

FIG. 4 is another representative view of the stationary terrestrial/satellite antenna and receiver system according to FIGS. 2A and 2B;

FIG. 5 is another view of the dual element stationary terrestrial/satellite antenna and receiver system according to FIG. 2A;

FIG. 6 illustrates a quadrifilar antenna etched on a flexible substrate that may be used in the stationary terrestrial/satellite antenna and receiver system according to the embodiments of the invention as shown in FIGS. 2A and 2B;

FIG. 7 is a schematic block diagram of the stationary terrestrial/satellite antenna and receiver according to FIG. 5;

FIG. 8 is another view of the single element stationary terrestrial/satellite antenna and receiver according to FIG. 2B;

FIG. 9 a schematic block diagram of the stationary terrestrial/satellite antenna and receiver according to FIG. 8;

FIG. 10 is another view of the single element stationary terrestrial/satellite antenna and receiver of FIG. 2B according to another embodiment of the invention;

FIGS. 11A-12C each illustrate the mechanical configurations of an integrated stationary terrestrial/satellite antenna according to another embodiment of the present invention; and

FIGS. 12A-12D each illustrate the mechanical configurations of an AM/FM antenna as applied to the antenna configurations of FIGS. 2A and 2B according to another embodiment of the present invention.

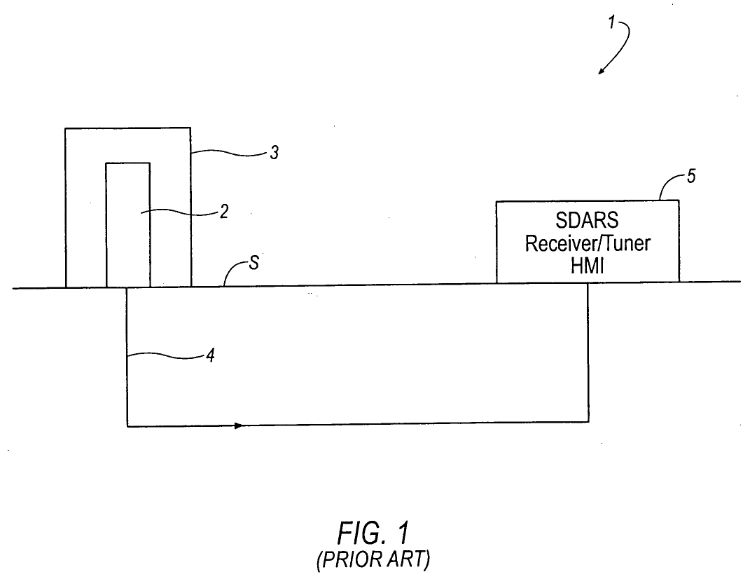

### DETAILED DESCRIPTION OF THE PREFERRED EMBODIMENTS

The various features of the preferred embodiment will now be described with reference to the drawings, in which like parts are identified with the same reference characters.

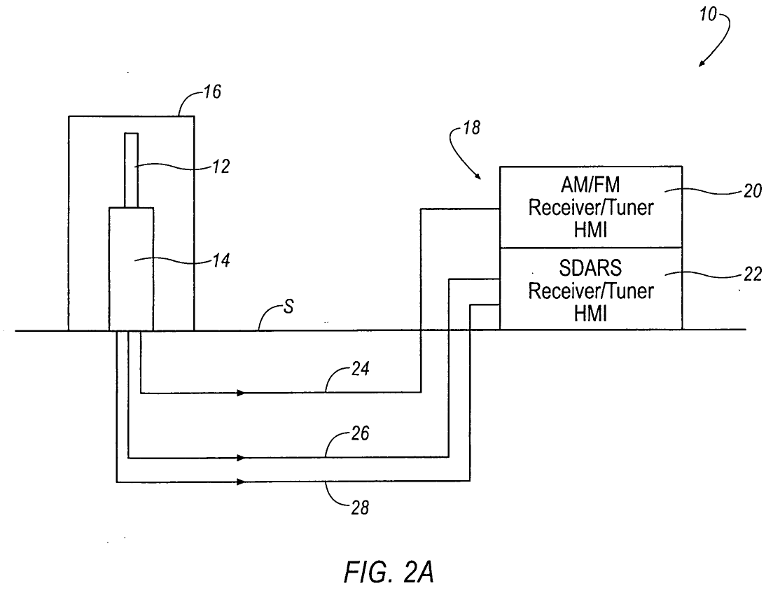

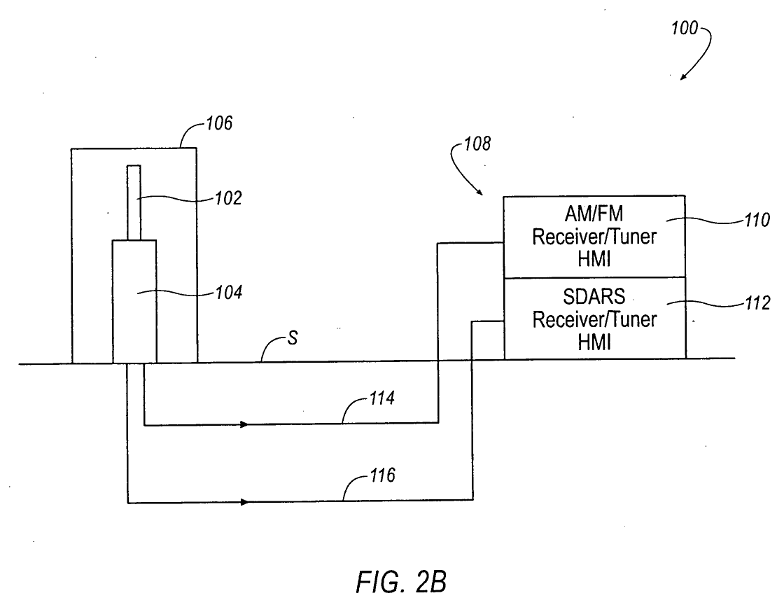

FIGS. 2A and 2B each illustrate a stationary terrestrial/satellite antenna and receiver systems for reception of AM, FM, satellite and terrestrial rebroadcast satellite signals at reference numerals 10 and 100, respectively. Each stationary terrestrial/satellite antenna and receiver systems 10, 100 are positioned on a surface, S, such as a desk, table, or countertop. Alternatively, the surface, S, may be window glass that faces the direction of satellite transmissions and includes an AM/FM multi-band terrestrial antenna 12, 102 and a satellite digital audio radio services (SDARS) antenna and electronics 14, 104 that are both enclosed by a housing 16, 106. Primarily, the multi-band terrestrial antenna 12, 102 is used for AM and FM radio reception. AM and FM radio is generally used for audio reception only, that is, for transmissions from local radio stations with various programming formats, including music, news, sports, “talk radio,” and so on. These programming formats are familiar to many people and are the kind that are commonly received by users in their homes, offices, vehicles and other stationary or mobile structures today.

As applied in the present invention, it is also contemplated that the multi-band terrestrial antenna 12, 102 may be used for two-way cellular telephony and for reception of terrestrial retransmission of a satellite transmitted signal. It is known that radio frequency transmissions are often subject to multipath fading; this is especially true of satellite transmitted signals. Signal blockages at receivers can occur due to physical obstructions between a transmitter and the receiver or other service outages. For example, receivers may be positioned in a location that encounters physical obstructions when the line of sight (LOS) signal reception is impeded. Service outages can occur when noise or multipath signal reflections are sufficiently high with respect to the desired signal. At these times, when a direct line-of-sight transmission path between the satellite and satellite antenna 14, 104 and terrestrial antenna 12, 102 is blocked, retransmission of the satellite signals from terrestrial retransmitters is very useful. In the illustrated embodiments of the present invention, the satellite antenna 14, 104 and terrestrial antenna 12, 102 are designed to receive satellite transmission signals directly from one or more satellites placed in synchronous or non-synchronous earth orbits, and terrestrial transmission signals from terrestrial repeaters.

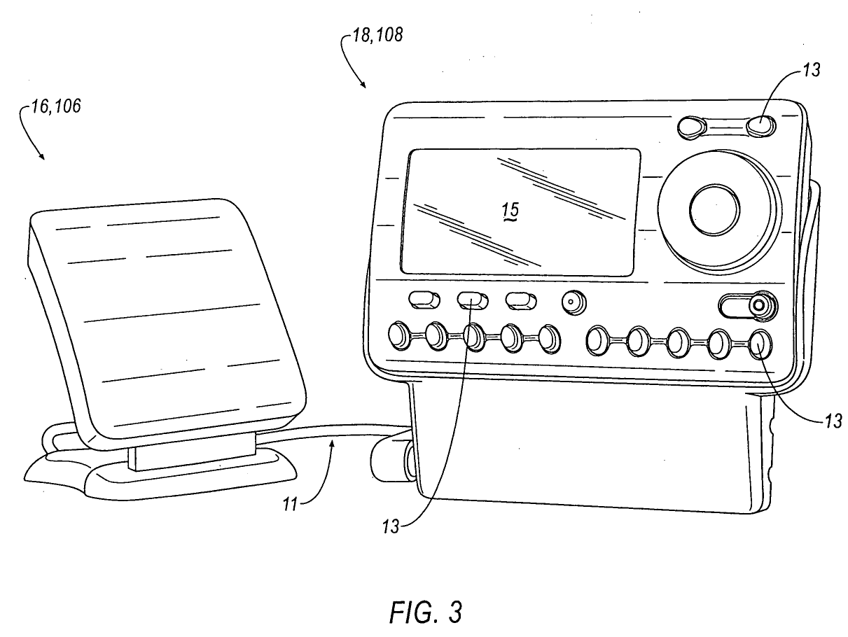

Once received at the antennas 12, 14 and 102, 104, the SDARS and AM/FM signals are communicated to an integrated head unit 18, 108, which may include an AM/FM receiver/tuner HMI 20, 110, an SDARS receiver/tuner HMI 22, 112, control buttons 13 (FIG. 3), a display 15 (FIG. 3), and a speaker output (not shown). The control buttons 13 may allow a subscriber to adjust the volume, toggle between AM, FM, and SDARS frequencies, or change the channel programming by pushing pre-programmed buttons or by adjusting the channel dial. The display 15 may show information pertaining to the programming on the channel, such as a song title, artist, or name of a talk show. As illustrated in both FIGS. 2A and 2B, an AM/FM cable 24, 114 communicates the AM/FM terrestrial signals received by the AM/FM antenna 12, 102 to the AM/FM receiver/tuner HMI 20, 110. Specifically relating to FIG. 2A, a dual element SDARS satellite (SDARS/SAT) cable 26 and SDARS terrestrial (SDARS/TER) cable 28 communicates the satellite signal and the terrestrial retransmission of a satellite (or cellular) signal, respectively. Alternatively, as illustrated in FIG. 2B, a single element SDARS satellite-terrestrial (SDARS/SAT/TER) cable 116 communicates satellite information and terrestrial rebroadcast information.

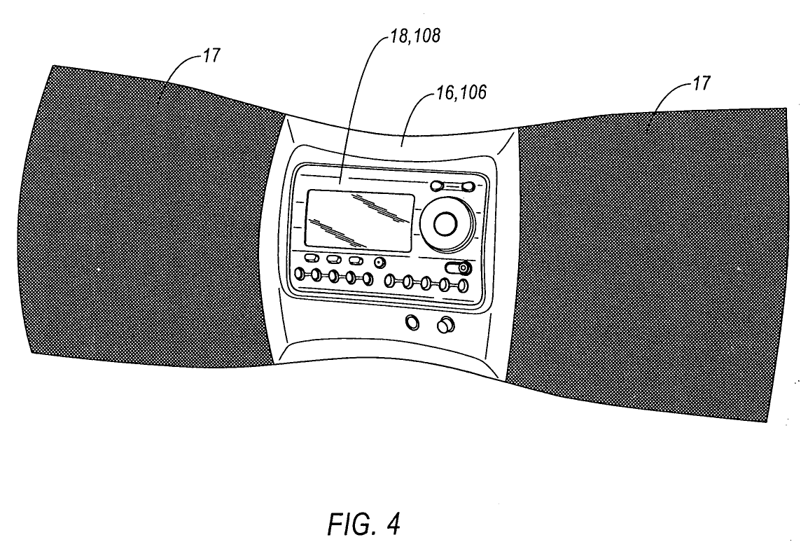

Referring to FIG. 3, the housing 16, 106 and integrated head unit 18, 108 may have any desirable shape or configuration. As illustrated, a combined conduit 11 extends from the housing 16, 106 to the integrated unit 18, 108. The conduit 11 includes the cables 24, 26, 28 according to FIG. 2A or the cables 114, 116 according to FIG. 2B. Although only one conduit 11 is illustrated, multiple, individual conduits 11 may extend from the housing 16, 106 to the integrated unit 18, 108 so as to completely maintain and isolate the received signals corresponding to each cable. Referring to FIG. 4, the integrated head unit 18, 108 may alternatively be received by the housing 16, 106; in this embodiment, the housing 16, 106 may resemble a boombox or similar device, which also comprises speakers 17.

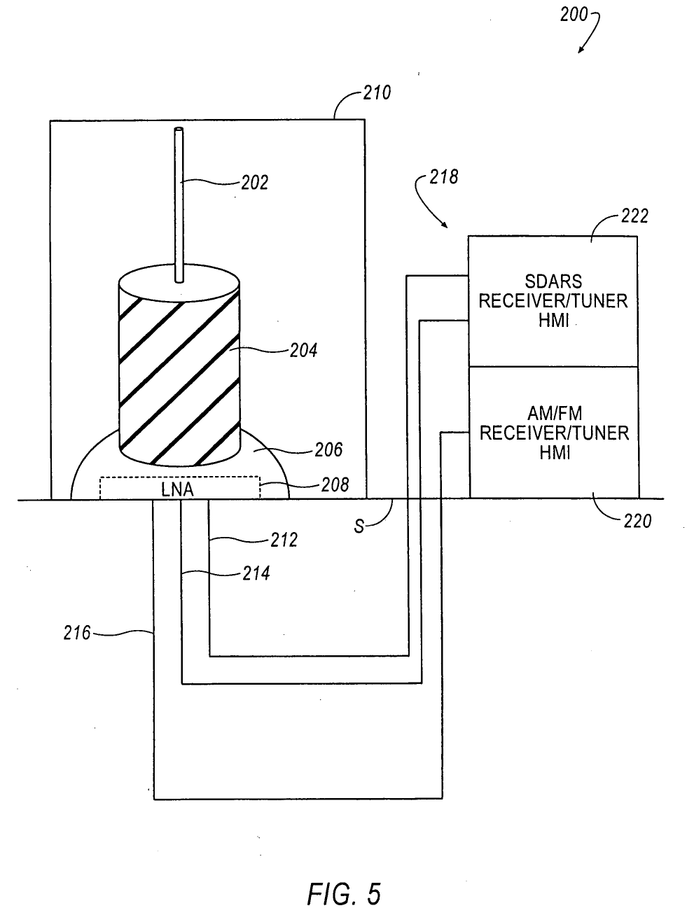

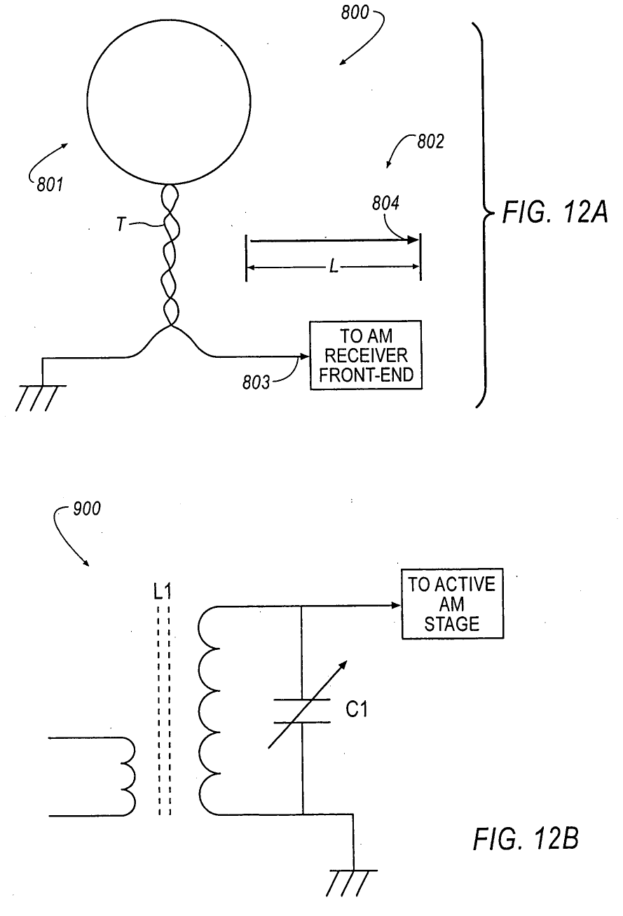

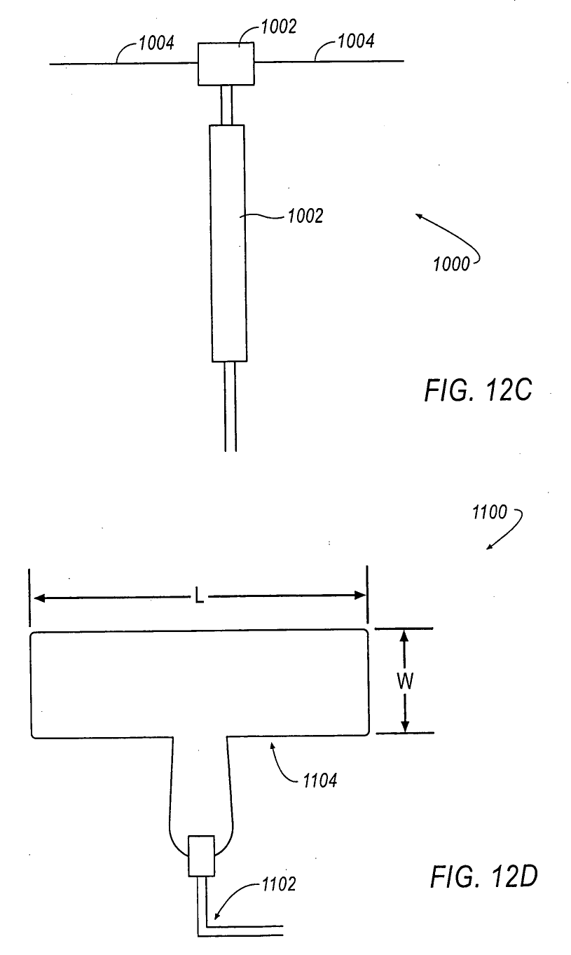

Referring now to FIG. 5, a dual element stationary terrestrial/satellite antenna and receiver system is seen generally at reference numeral 200, which is positioned on a surface, S. The dual element stationary terrestrial/satellite antenna and receiver system 200 includes a combined multi-band terrestrial and satellite antenna system for reception of AM, FM, satellite and terrestrial rebroadcast-satellite signals. The system 200 includes a multi-band terrestrial antenna 202, satellite antenna 204, a bezel 206, and a low noise amplifier (LNA) housing 208 that are all located in a housing 210, which may be a boombox or similar device as described above. A SDARS/SAT cable 212, a SDARS/TER cable 214, and an AM/FM cable 216 extends from the housing 210 to communicate satellite signals, terrestrial rebroadcast signals, and AM/FM terrestrial signals. Similarly as discussed above, the cables 212, 214, 216 may each be disposed in an individual conduit, or, alternatively, the cables 212, 214, 216 may be located in one conduit, carrying all three cables. The multi-band terrestrial antenna 202 may include any desirable AM/FM antenna, such as a folded-dipole, to receive AM and FM transmitted signals and terrestrial retransmission of satellite signals. Other embodiments of the multi-band terrestrial antenna 202 are discussed in greater detail in FIGS. 12A-12D.

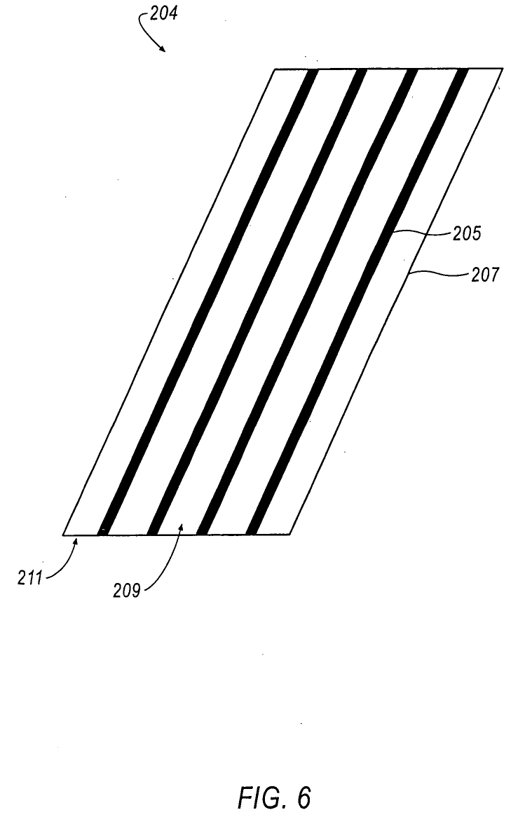

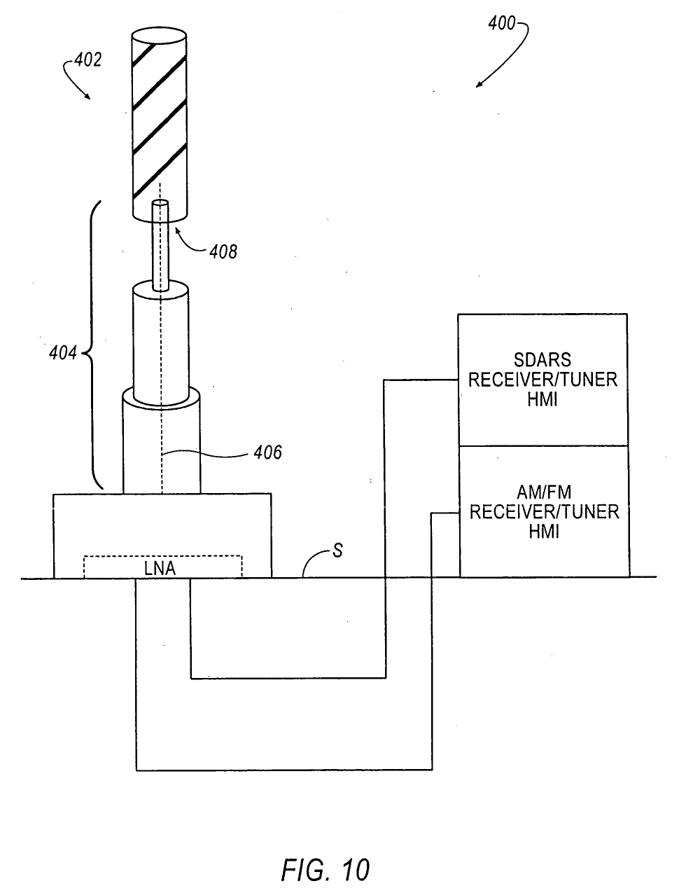

The satellite antenna 204 includes a helical element to receive satellite transmitted signals directly. For example, as seen in FIG. 6, the helical element may be a quadrifilar antenna etched on a flexible substrate. The quadrifilar helix antenna includes conductive quadrifilar antenna elements 205 that are etched on a flexible insulating substrate 207. A weatherproofing material, if desired, may be applied to the exterior surface 209 of the substrate 207 to protect the quadrifilar antenna elements 205 from the deteriorating effects of rain, sunshine, etc. (i.e., if a housing 210 is not implemented, which is discussed in greater detail with respect to the illustrated embodiment of FIG. 10). Additionally, a binding agent (not shown) may be applied to the interior surface 211 of the quadrifilar antenna when fabricated into the final desired form as shown in FIG. 5.

Referring back to FIG. 5, the antennas 202, 204 are two distinct antennas, as applied to SDARS signals (i.e. direct satellite signals and terrestrial rebroadcast-satellite signals), that are physically separated, including three cables that function in providing the satellite signal (SDARS/SAT cable 212), the terrestrial rebroadcast satellite signals (SDARS/TER cable 214), and the AM/FM terrestrial signals (AM/FM cable 216). The three cables 212, 214, 216 provide a communication path to the integrated head unit 218 which includes the AM/FM and SDARS receiver/tuner HMI 220, 222.

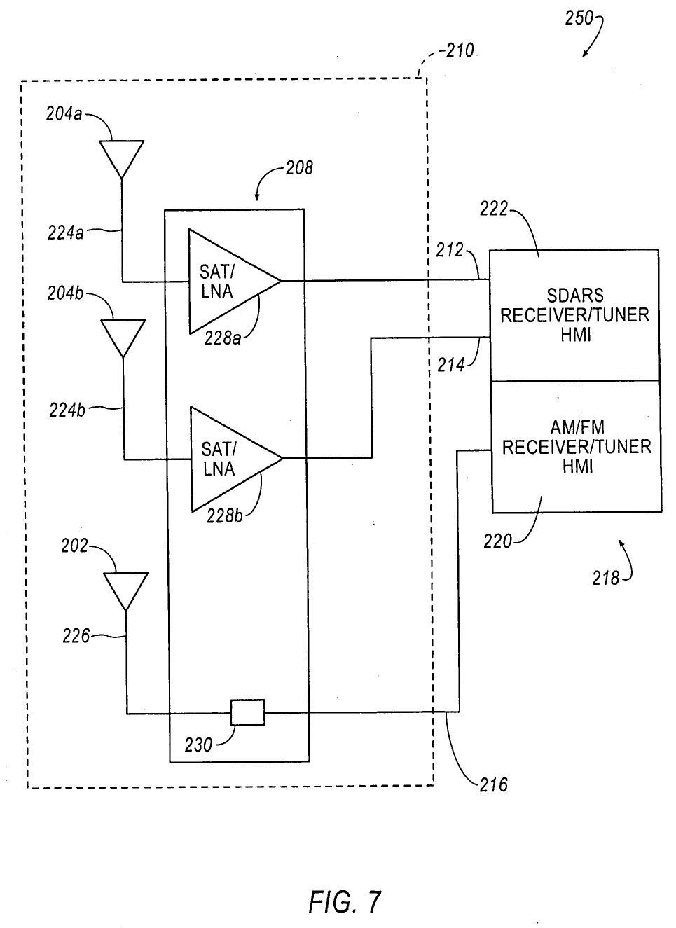

Referring to FIG. 7, a schematic block diagram of the stationary terrestrial/satellite antenna and receiver system 200 is seen generally at reference numeral 250. The satellite antenna 204 may comprise dual elements for receiving satellite and terrestrial- rebroadcast satellite signals. More specifically, the satellite antenna 204 comprises an antenna 204a dedicated to satellite transmissions and a terrestrial antenna 204b dedicated to terrestrial-rebroadcasts of satellite signals. As seen in the Figure, the antenna 204a is directly attached at line 224a to a satellite low-noise amplifier (SAT/LNA) 228a, the output of which is the SDARS/SAT cable 212, and the antenna 204b is directly attached at line 224b to another SAT/LNA 228b, the output of which is the SDARS/TER cable 214. Essentially, the antennas 204a, 204b and SAT/LNAs 228a, 228b are all contained in one housing, which is seen at element 210. As discussed above, the SAT/LNAs 228a, 228b may also be located in a housing within the housing 210, which is seen at element 208. Similarly, the multi-band terrestrial antenna 202 is directly attached at line 226. According to one embodiment of the invention, line 226 may be directly attached to an active AM/FM stage 230 inline at the base of the terrestrial antenna 202; alternatively, the line 226 may be the AM/FM cable 216 that is attached to and directly extends from the antenna 202 out of the housing 210 to the AM/FM receiver/tuner HMI 220. The SDARS receiver/tuner HMI 222 receives SDARS/SAT cable 212 and the SDARS/TER cable 214. The integrated head unit 218 processes the information provided by the cables 212, 214, 216 and outputs usable information to the subscriber, such as an audio signal or visual data.

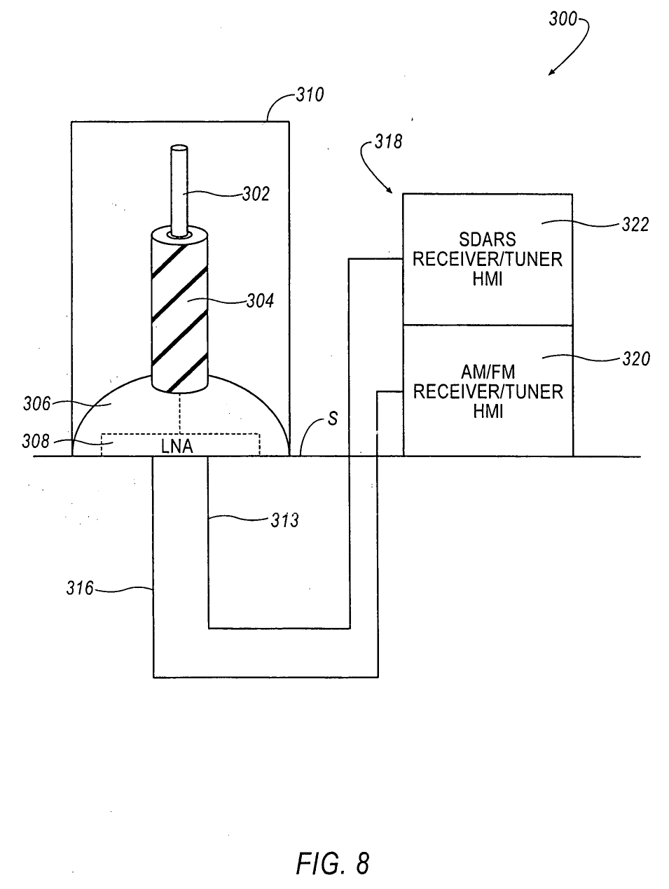

FIG. 8 illustrates a stationary terrestrial/satellite antenna and receiver 300 for reception of AM, FM, satellite and terrestrial rebroadcast satellite signals according to another embodiment of the present invention. This embodiment of the invention generally includes the same elements as described in FIG. 5, except for the fact that the stationary terrestrial/satellite antenna and receiver 300 includes a single element SDARS satellite-terrestrial (SDARS/SAT/TER) cable 313, which carries the amplified received satellite signal and the amplified terrestrial retransmission of a satellite (or cellular) signal. The second cable is the AM/FM cable 316, which carries the AM/FM terrestrial signals received by the AM/FM terrestrial antenna 302.

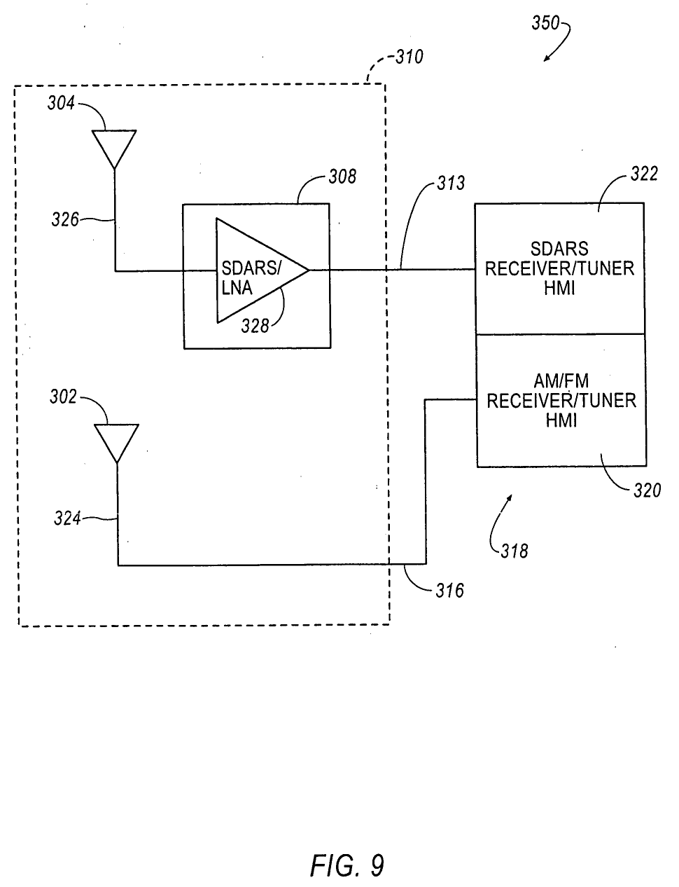

Referring now to FIG. 9, a schematic block diagram of the stationary terrestrial/satellite antenna and receiver system 300 is seen generally at reference numeral 350. Connected to each antenna 302, 304 are outputs seen at lines 324 and 326, respectively. Similarly as described above, line 324 may be directly attached to an active AM/FM stage (not shown) inline at the base of the terrestrial antenna 302; alternatively, as illustrated, the line 324 may be the AM/FM cable 316 that is attached to and directly extends from the antenna 302 and out of the housing 310 to the AM/FM receiver/tuner HMI 320. The line 326 is input to the LNA housing 308, which includes a SDARS/LNA 328. Correlating to FIG. 8, the stationary terrestrial/satellite antenna and receiver system 300 includes two cables; a single output cable is seen as the output of the SDARS/LNA 328, which is SDARS/SAT/TER cable 313, and at the AM/FM terrestrial antenna 302, which is, essentially, the output cable 324 that functions as the AM/FM cable 316. As explained above, the integrated head unit 318 processes the information provided by the cables 313, 316 and outputs usable information to the subscriber, such as an audio signal or visual data.

Although the antennas described in FIGS. 2A and 2B are illustrated in a housing 16, 106, it is also contemplated that the antenna systems may also employ a housing-free mast antenna. For example, as seen in FIG. 10, a single element stationary terrestrial/satellite antenna and receiver system 400 includes a single element satellite and terrestrial antenna 402 placed concentrically around a retractable or fixed mast AM/FM terrestrial antenna 404, which may be approximately 24-32 inches in length, that are connected by a coaxial cable 406. The single element satellite and terrestrial antenna 402 includes a terrestrial antenna bore 408 located at or near the center of single element satellite and terrestrial antenna 402 to receive the AM/FM terrestrial antenna 404. Although the retractable or fixed mast antenna 404 is positioned under the single element satellite and terrestrial antenna 402, the mast antenna 404 may be concentrically located about the satellite antenna 402 in a similar fashion as shown in FIGS. 5 and 8 or in any other desirable orientation regardless of mechanics of the AM/FM terrestrial antenna 404.

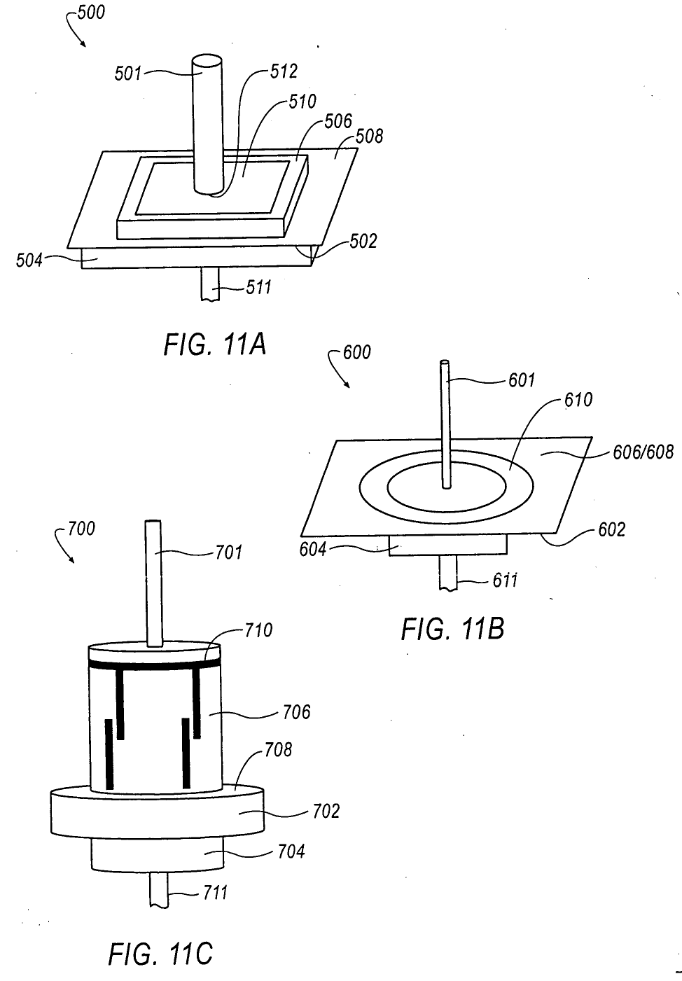

It is also contemplated that antenna structures other than the quadrifilar antenna structure as illustrated in FIG. 6 may be substituted for the single or dual element satellite antenna embodiments as shown in FIGS. 5, 8, and 10. For example, three alternative embodiments are illustrated in FIGS. 11A-11C at 500, 600, and 700. The antennas implemented in the antenna systems as illustrated in FIGS. 5, 8, and 10 may alternatively include a patch antenna 500 (FIG. 11A), a loop antenna 600 (FIG. 11B), or a coupled-loop antenna 700 (FIG. 11C). As illustrated, each antenna 500, 600, 700 includes a terrestrial antenna element 501, 601, 701 and AM/FM, SDARS/SAT and/or SDARS/TER cables that are located in a conduit 511, 611, 711. Each antenna 500, 600, 700 may be coupled to a structural element, such as a circuit board 502, 602, 702 or substrate 506, 606, 706, and an LNA 504, 604, 704. Each antenna 500, 600, 700 may also include a weatherproofing material (not shown) that may be applied to its exterior surface for protection against the deteriorating effects of rain, sunshine, etc. Additionally, a binding agent (not shown) may also be applied to the interior surface of the antennas 500, 600, 700 when fabricated into the final form as shown in FIGS. 11A-11C.

Referring specifically to FIG. 11A, the patch antenna 500 may also include a circuit board 502, which has ground plane 508 on both sides of the circuit board 502, positioned under the substrate 506 , and a conductive area 510 positioned over the LNA 504, which includes a feed point 512. The feed point 512 receives a pin (not shown) that extends through the LNA 504 for assembly and electrical communication purposes, which is subsequently soldered for directly connecting the antenna assembly. Referring now to FIG. 11B, the loop antenna 600 also includes a generally planar substrate/circuit board 606/608, and a generally circular or oval conductive area 610. As illustrated, the circuit board 602, may act not only as a planar substrate 606, but also as a ground plane 608. FIG. 11C illustrates an alternative embodiment of the loop antenna 600, such that the conductive element 710 is wrapped or disposed upon a generally tubular or cylindrical substrate 706 that is positioned over the ground plane 708. As seen in Figure 11C, the conductive element 710 is essentially a loop that is wrapped about the cylindrical substrate 706. As illustrated, the conductive element 710 comprises at least one loop portion with conductive strips that extend in a generally perpendicular pattern from the loop. According to the illustrated embodiments of the antennas in FIGS. 11A and 11B, the antennas 500, 600 may be directly coupled to the LNA 504, 604 via a soldering technique that includes a feed point at, on, or about the conductive element 510, 610 as described above. Alternatively, the conductive elements 710 of the antenna 700 illustrated in FIG. 11C are parasitic elements and are parasitically coupled with respect to the main conductive element 710 where the main conductive element 710 is directly coupled to the LNA 704.

It is known that antenna impedance is referenced from the ground; therefore, it is preferable to introduce the ground plane 508, 608, 708 on circuit boards 502, 602, 702 in the design of the antennas 500, 600, 700 to avoid undesirable ripple to obtain a smooth polar response. It is preferable to maintain a minimum circuit board ground plane 508, 608, 708 of approximately 100 sq-mm or 100 mm-diameter regardless of antenna position. If the antenna 500, 600, 700 is positioned on glass, then ground plane 508, 608, 708 may be introduced without any structural alterations to the antenna 500, 600, 700; however, if the antenna 500, 600, 700 is located on the front or rear dash, the ground plane 508, 608, 708 is not effected because the a ground plane already exists on the front or rear dash. Although not illustrated in FIGS. 5, 8, and 10, it is also contemplated that the antenna systems 200, 300 may also include a ground plane as well.

Referring to FIG. 11A, the dielectric dimensions, dielectric constant, and dimensions of the conductive patch element 510 and the ground plane 508 determine the operating characteristics of the patch antenna 500. According to one embodiment of the invention, the patch antenna 500 may be defined to include an approximate surface area of 1 square inch and height of approximately 4 mm to 6 mm. The conductive patch element 510 may be approximately 0.5 square inches. Referring to FIG. 11B, the loop or micro-strip antenna 600 may be etched on a low-loss dielectric. The loop antenna 600 operates in the TM21 mode and yields adequate performance for elevation angles approximately equal to 20 to 60 degrees and degraded performance at higher angles such as 70 to 90 degrees. Referring now to FIG. 11C, the ground plane 708, diameter, and length of the conductive elements 710 determine the operating characteristics of the coupled loop antenna 700. According to one embodiment of the invention, the loop perimeter length may be approximately ½ wavelength and the height may be approximately equal to 30 mm. Referring back to FIG. 6, the diameter, height, and pitch angle of helical conductive elements 205 determine the operating characteristics of the quadrifilar antenna. According to one embodiment of the invention, the quadrifilar antenna may include a diameter approximately equal to 20 mm and a height ranging from 6.0 cm to 6.5 cm. Although not illustrated, it is contemplated that any desired alternative antenna may be implemented in the design of the antenna system 200, 300 other than the antenna systems as illustrated in FIGS. 11A-11C. For example, an alternative antenna that may be applied to the antenna system 200, 300 is a cross-dipole antenna that receives terrestrial signals which includes AM/FM and SDARS signals. Essentially, the cross-dipole antenna may comprise two circuit boards each including a dipole that are crossed at a 90° angle. Feed points of the circuit boards may be varied in any desirable polarization such as a horizontal, vertical, left-hand, right-hand polarization, by varying tapping points 90°, 180°, or 270°.

It is also contemplated that other antenna structures may be substituted for the AM/FM terrestrial antenna than the structures illustrated in FIGS. 5, 8, and 10. For example, four alternative embodiments are illustrated in FIGS. 12A-12D at 800, 900, 1000, and 1100. As seen in FIG. 12A, an AM loop antenna 801 and an FM wire antenna 802 is shown generally at 800. The AM loop antenna 801 includes any desirable number of loop turns, T, such as, for example, 6-8 loop turns, and the FM wire antenna 802 includes any desirable length, L, such as, for example, approximately 32-40 inches. The AM/FM receiver HMI receives two separate inputs, which are generally seen at 803, 804 for the AM and FM signals, respectively. As seen in FIG. 12B, an active AM ferrite antenna is seen generally at 900. The AM ferrite antenna 900 includes a tuned circuit formed from the inductor, L1, and capacitor, C1, which is fed into a source-follower buffer stage. As seen in FIG. 12C, an FM dipole antenna is seen generally at 1000. The FM dipole antenna includes two metallic rods 1002 that are ¼ wavelength apart and are mounted horizontally with respect to each other. As illustrated, one lead-in wire 1004 is connected to each rod, which results in an antenna impedance of 75 ohms, the transmission lead-in of which is also 75 ohms. As seen in FIG. 12D, a folded dipole antenna is seen generally at 1100, which includes a 300 ohm twin lead 1102 and two ½ wave dipoles 1104 placed in parallel to each other with both ends terminated at the twin lead 1102 feedpoints. The length, L, and width, W, may be any desirable dimension, such as, for example, 0.93×½ wavelength and 2-3 inches, respectively. Although each AM/FM antenna 800-1100 is illustrated as a separate unit, each AM/FM antenna 800-1100 may be attached to the satellite antenna element or the integrated head unit, if desired. If applied as part of the SDARS antenna, the AM/FM antenna 800-110 may include an amplifier to overcome cable losses.

The present invention has been described with reference to certain exemplary embodiments thereof. Accordingly, a stationary terrestrial/satellite antenna and receiver system for reception of AM, FM, satellite and terrestrial rebroadcast satellite signals is achieved. The stationary terrestrial/satellite antenna and receiver system provides national broadcast content and local broadcast content. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

1. A stationary terrestrial/satellite antenna and receiver system for reception of AM, FM, satellite and terrestrial rebroadcast satellite signals, comprising:
a stationary satellite antenna positioned on a surface that receives satellite signals and terrestrial rebroadcast satellite signals;
a stationary terrestrial antenna positioned on the surface that receives AM/FM signals, wherein the satellite and terrestrial antenna are mounted on a mounting assembly including a low noise amplifier circuit and a bezel, wherein the bezel is adapted to contain the low noise amplifier; and
a stationary integrated head unit positioned on the surface including an AM/FM terrestrial receiver/tuner human interface and a satellite receiver/tuner human interface, wherein the terrestrial antenna is connected to the AM/FM terrestrial receiver/tuner human interface and the satellite antenna is connected to the satellite receiver/tuner human interface via a conduit.

2. The stationary terrestrial/satellite antenna and receiver system according to claim 1, wherein:
the satellite signals received by the satellite antenna is SDARS signals.

3. The stationary terrestrial/satellite antenna and receiver system according to claim 2, wherein the satellite antenna comprises:
a quadrifilar helix antenna.

4. The stationary terrestrial/satellite antenna and receiver system according to claim 2, wherein the satellite antenna comprises:
a patch antenna.

5. The stationary terrestrial/satellite antenna and receiver system according to claim 2, wherein the satellite antenna comprises:
a loop antenna.

6. The stationary terrestrial/satellite antenna and receiver system according to claim 2, wherein the satellite antenna comprises:
a coupled-loop antenna.

7. The stationary terrestrial/satellite antenna and receiver system according to claim 1, wherein the terrestrial antenna comprises:
a retractable mast antenna.

8. The stationary terrestrial/satellite antenna and receiver system according to claim 1, wherein the terrestrial antenna comprises:
an AM loop antenna and an FM wire antenna.

9. The stationary terrestrial/satellite antenna and receiver system according to claim 1, wherein the terrestrial antenna comprises:
an active AM ferrite antenna.

10. The stationary terrestrial/satellite antenna and receiver system according to claim 1, wherein the terrestrial antenna comprises:
a FM dipole antenna.

11. The stationary terrestrial/satellite antenna and receiver system according to claim 1, wherein the terrestrial antenna comprises:
a folded FM dipole antenna.

12. The stationary terrestrial/satellite antenna and receiver system according to claim 1, wherein the low noise amplifier circuit comprises:
a satellite low noise amplifier with a first input connected to a first end of a satellite output, wherein the output of the low noise amplifier is the SDARS/SAT/TER cable.

13. The stationary terrestrial/satellite antenna and receiver system according to claim 1, wherein the surface is selected from the group consisting of an desk, table, countertop, or window glass.

14. The stationary terrestrial/satellite antenna and receiver system according to claim 1, wherein the satellite and terrestrial antenna are disposed in a housing.

15. The stationary terrestrial/satellite antenna and receiver system according to claim 1, wherein the stationary satellite antenna is concentrically mounted with respect to the terrestrial antenna.

16. The stationary terrestrial/satellite antenna and receiver system according to claim 15, wherein the terrestrial antenna is a retractable terrestrial antenna.

17. The stationary terrestrial/satellite antenna and receiver system according to claim 1, wherein the conduit includes a satellite-cable, a satellite-terrestrial rebroadcast cable and a terrestrial AM/FM cable.

18. The stationary terrestrial/satellite antenna and receiver system according to claim 1, wherein the conduit includes a single element satellite-terrestrial-rebroadcast-satellite cable and a terrestrial AM/FM cable.
